(19) United States
(12) Patent Application Publication
(10) Pub. No.: US 2013/0121529 A1
(43) Pub. Date: May 16, 2013

(54) MILLIMETER-WAVE SUBJECT SURVEILLANCE WITH BODY CHARACTERIZATION FOR OBJECT DETECTION

(71) Applicant: L-3 Communications Security and Detection Syst, Woburn, MA (US)

(72) Inventors: Michael Fleisher, Santa Clara, CA (US); Oliver Shih, San Jose, CA (US)

(73) Assignee: L-3 Communications Security and Detection Systems, Inc., Woburn, MA (US)

(21) Appl. No.: 13/677,749

(22) Filed: Nov. 15, 2012

Related U.S. Application Data
(60) Provisional application No. 61/560,265, filed on Nov. 15, 2011.

(51) Int. Cl. G06K 9/78

(52) U.S. Cl. CPC G06K 9/78
USPC 382/103

(57) ABSTRACT

An imaging apparatus may include an interrogating apparatus, such as a scanner, configured to transmit toward and receive from a test subject in a target position, electromagnetic radiation in a frequency range of about 100 MHz to about 2 THz. The interrogating apparatus or scanner may produce an image signal representative of the received radiation. A controller may store in memory reference-image data for at least one reference subject. The controller may produce test-image data from the image signal and may compare at least a portion of the test-image data with at least a portion of the reference-image data for the at least one reference subject.

### RELATED APPLICATION

This application claims the benefit of U.S. Provisional Patent Application No. 61/560,265 filed on Nov. 15, 2011 for Millimeter-Wave Subject Surveillance with Body Feature Detection, which application is incorporated herein by reference in its entirety for all purposes.

### BACKGROUND

Millimeter wave signals are used for radar and telecommunications. They are also capable of being used to generate data representative of a subject, by directing millimeter-wave signals at the subject and detecting the reflected signal. The data generated may then be used to produce an image of the subject. U.S. Pat. No. 7,386,150 discloses an imaging system that provides body identification, which patent reference is incorporated herein by reference.

### BRIEF SUMMARY

In one example, a method of interrogating a test subject with an imaging apparatus may be provided. The test subject may include a person and any discernible objects with the person. Prior to interrogating the test subject, reference-image data for at least one reference subject produced from an earlier image signal received during interrogation of the at least one reference subject with electromagnetic radiation in a range of about 100 MHz to about 2 THz may be stored in a memory of the imaging apparatus. The imaging apparatus may transmit electromagnetic radiation in a frequency range of about 100 MHz to about 2 THz, from positions spaced from the target position toward a target position in which the test subject is positioned. Electromagnetic radiation emitted from the test subject in response to the transmitted electromagnetic radiation may be received from the test subject. An image signal representative of the received radiation may be produced. Test-image data corresponding to a test-subject image of at least a portion of the test subject may be produced from the image signal. At least a portion of the test-image data may be compared with a corresponding at least a portion of the reference-image data for the at least one reference subject. In some examples one or more non-transitory storage media having embodied therein a program of commands adapted to be executed by a computer processor of an imaging apparatus to perform steps of such a method.

In some examples, an imaging apparatus may include an interrogating apparatus and a controller. The interrogating apparatus may be configured to transmit toward and receive from a test subject, including a person and any discernible objects with the person, in a target position, electromagnetic radiation in a frequency range of about 100 MHz to about 2 THz, from positions spaced from the target position. The interrogating apparatus may produce an image signal representative of the received radiation. The controller may include a processor and a memory. The memory may store reference-image data for at least one reference subject produced from an earlier image signal received during interrogation of the at least one reference subject with electromagnetic radiation in a range of about 100 MHz to about 2 THz. The controller may be configured to produce from the image signal test-image data corresponding to a test-subject image of at least a portion of the test subject. The controller may also be configured to compare at least a portion of the test-image data corresponding to the test-subject image with a corresponding at least a portion of the reference-image data for the at least one reference subject.

### BRIEF DESCRIPTION OF THE SEVERAL FIGURES

FIG. 1 is a general diagram showing a surveillance imaging system.

FIG. 2 is a general diagram showing an example of an imaging system according to FIG. 1.

FIG. 3 is a general flow chart illustrating an example of a method of operation of an imaging system of FIG. 1 or FIG. 2.

FIG. 4 is a chart illustrating an example of a classification scheme involving three tiers of classification of a subject.

FIG. 5 illustrates a graphic example of comparing reference-image data with test-image data during anomaly identification.

FIG. 6 illustrates the example of FIG. 5 in which an area of interest on a test image is compared to corresponding reference data, such as an area on a reference image, to enhance anomaly detection.

### DETAILED DESCRIPTION OF VARIOUS EMBODIMENTS

There are situations in which it is desirable to identify features of a subject, particularly features of a person and any objects carried by the person. For example, it may be desired to determine whether the subject includes objects not apparent from a visual inspection of the subject. For example, when monitoring people prior to entry into a controlled-access environment, such as a public, private or government facility, building or vehicle, the accuracy of observation may be benefited by employing millimeter-wave imaging technology. Regardless of the application, the benefits derived from the monitoring may depend on the speed and accuracy of the monitoring, and where appropriate, the effectiveness of identifying visually hidden objects. The detection of the location of parts of the person's body, such as the head, one or both legs, a privacy sensitive area, or other features, may assist in processing images of a subject, such as identifying objects or modifying an image to protect privacy concerns.

In the description and claims that follow, the terms “feature” and “characteristic” may be synonymous or related. For example, intensity, color, depth or distance relative to a reference, and values of intensity, color or depth may be considered to be features or characteristics of an image or picture element of an image. Further, one may be an aspect of the other. For example, image intensity may be a feature, and darkness, lightness, and variation may be characteristics of the intensity.

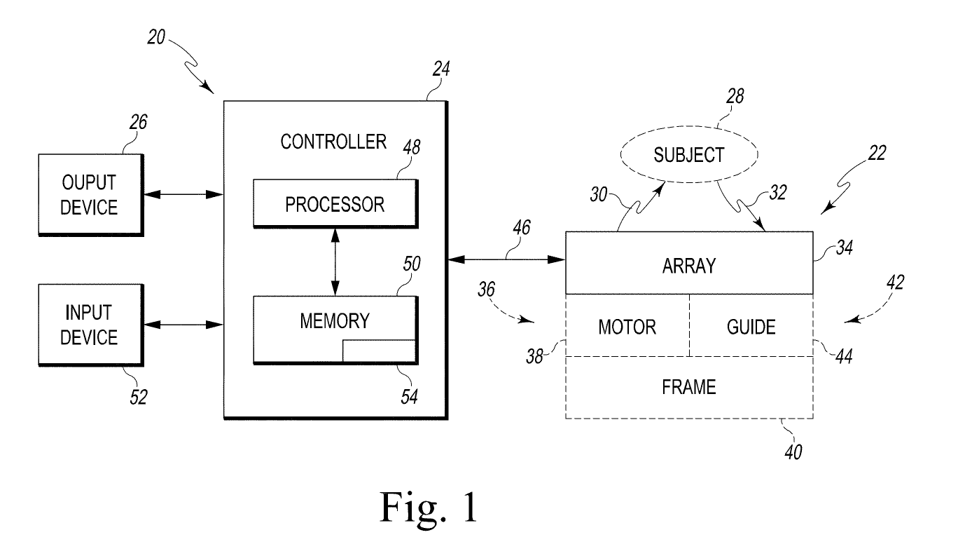

Shown generally at 20 in FIG. 1 is an exemplary imaging system, also referred to as an imaging apparatus. System 20 may include an interrogating apparatus 22, a controller 24, and in some systems, an output device 26. An imaging system 20 adapted to identify objects on a person's body may display identified objects on an output device in the form of a monitor or other display device for observation by a system operator or other user. The system may interrogate a subject 28, also referred to as a test subject, such as by scanning, in the sense that the interrogating apparatus transmits electromagnetic radiation 30 toward the subject, and in response, the subject emits or reflects electromagnetic radiation 32 that is detected by the interrogating apparatus. Optionally, interrogating apparatus may include physically and/or functionally separate or combined apparatus that collectively provide physical, electronic and/or virtual electromagnetic radiation and detection of radiation emitted from a subject. The interrogating apparatus 22 disclosed is also referred to herein as a scanner 22 that scans a subject during interrogation.

Subject 28 may include all that is presented for scanning by a scanning system, whether human, animal, or inanimate object. For example, if a person is presented for scanning, subject 28 may include the entire person's body or a specific portion or portions of the person's body. Optionally, subject 28 may include one or more persons, animals, objects, or a combination of these.

System 20 may be adapted to scan subject 28 by irradiating it with electromagnetic radiation, and detecting the reflected radiation. Electromagnetic radiation may be selected from an appropriate frequency range, such as in the range of about 100 megahertz (MHz) to 2 terahertz (THz), which range may be generally referred to herein as millimeter-wave radiation. Accordingly, imaging, or the production of images from the detected radiation, may be obtained using electromagnetic radiation in the frequency range of one gigahertz (GHz) to about 300 GHz. Radiation in the range of about 5 GHz to about 110 GHz may also be used to produce acceptable images. Some imaging systems use radiation in the range of 24 GHz to 30 GHz. Such radiation may be either at a fixed frequency or over a range or set of frequencies using one or more of several modulation types, e.g. chirp, pseudorandom frequency hop, pulsed, frequency modulated continuous wave (FMCW), or continuous wave (CW).

Certain natural and synthetic fibers may be transparent or semi-transparent to radiation of such frequencies and wavelengths, permitting the detection and/or imaging of surfaces positioned beneath such materials. For example, when the subject of a scan is an individual having portions of the body covered by clothing or other covering materials, such as a cast, wound dressings, bandages, or the like, information about portions of the subject's body covered by such materials can be obtained with system 20, as well as those portions that are not covered. Further, information relative to objects carried or supported by, or otherwise with a person beneath clothing can be provided with system 20 for metal and non-metal object compositions, such as those used for prosthetic devices and the like.

Many variations of scanner 22 are possible. For example, the scanner may include any suitable combination, configuration and arrangement of transmitting and/or receiving antennae that provides scanning of a subject, such as an array 34 of one or more antenna units, each of which may further include a single antenna that transmits and receives radiation, a plurality of antennae that collectively transmit and receive radiation, or separate transmitting and receiving antenna. Optionally, some embodiments may employ one or more antennae apparatus as described in U.S. Pat. No. 6,992,616 entitled “Millimeter-Wave Active Imaging System”, the disclosure of which is incorporated herein by reference.

Depending on the scanner, an imaging system may include an apparatus moving mechanism 36, represented by a motor 38, which may move scanner 22 relative to a subject 28, may move one or more of a subject, one or more transmitting antennae, one or more receiving antennae, or a combination of these. Each motion mechanism 36 may be mounted relative to a frame 40 for moving the apparatus along a path defined by a movement control mechanism 42, such as a guide 44, including any associated motor indexers, encoders or other controls, as appropriate. The motion mechanism may be any appropriate mechanism that moves the scanner, a part of the scanner, and/or a subject, and may include a servomotor, stepper motor, or other suitable device.

Scanner 22 may be coupled to controller 24. As contemplated herein, the controller may include structure and functions appropriate for generating, routing, processing, transmitting and receiving millimeter-wave signals to and from the scanner. The controller, in this comprehensive sense, may include multiplexed switching among individual components of the scanner, transmit and receive electronics, and mechanical, optical, electronic, and logic units. The controller thus may send to and receive from the scanner signals 46, which may include appropriate signals, such as control signals and data signals.

Controller 24 may control operation of motor 38, and coordinate the operation of scanner 22 with movement any of the scanner or portions of the scanner. Controller 24 may include hardware, software, firmware, or a combination of these, and may be included in a computer, computer server, or other microprocessor-based system capable of performing a sequence of logic operations. In addition, processing may be distributed with individual portions being implemented in separate system components.

Accordingly, controller 24 may include a processor 48 and a memory 50. Controller components such as output devices, processors, memories and memory devices, and other components, may be wholly or partly co-resident in scanner 22 or be wholly or partly located remotely from the scanner.

Processor 48 may process data signals received from the scanner. The processor thus may include hardware, software, firmware, or a combination of these, and may be included in a computer, computer server, or other microprocessor-based system capable of performing a sequence of logic operations. The processor may be any analog or digital computational device, or combination of devices, such as a computer(s), microprocessor(s), or other logic unit(s) adapted to control scanning a subject and receiving data signals 46, and to generate image data representative of at least a portion of the subject scanned.

The description that follows is presented largely in terms of display images, algorithms, and symbolic representations of operation of data bits stored within computer memory. Software, firmware, and hardware encompassing such representations may be configured many different ways, and may be aggregated into one or more processors and programs with unclear boundaries.

An algorithm is generally considered to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. When stored, they can be stored, transferred, combined, compared, and otherwise manipulated. When stored, they may be stored in any computer-readable medium. As a convention, these signals may be referred to as bits, values, elements, symbols, characters, images, terms, numbers, or the like. These and similar terms may be associated with appropriate physical quantities and are convenient labels applied to these quantities.

In the present case, the operations may include machine operations that may be performed automatically and/or in conjunction with a human operator. Useful machines for performing the operations disclosed include general-purpose digital computers, microprocessors, or other similar devices. The present disclosure also relates to apparatus for performing these operations. This apparatus may be specially constructed for the required purposes or it may comprise a general-purpose computer selectively activated or reconfigured by a computer program stored in the computer or other apparatus. In particular, various general-purpose machines may be used with programs in accordance with the teachings herein, or it may prove more convenient to construct more specialized apparatus to perform the required method steps.

A program or programs embodying the disclosed methods need not reside in a single memory, or even a single machine. Various portions, modules or features of them can reside in separate memories, or even separate machines. The separate machines may be connected directly, or through a network, such as a local access network (LAN), or a global network, such as what is presently generally known as the Internet. Similarly, the machines need not be collocated with each other.

Image data may include any data or data sets derived from a scan of a subject or relating to or associated with a past, present or future subject, whether processed, partially processed or unprocessed, or sub-sets of data, such as data for a portion of a subject; data that is manipulated in order to identify information corresponding to one or more given features of a subject; data that is manipulated or processed in order to present, for viewing by an operator or by another processor, information corresponding to one or more given features of a subject; or measurements or other information relating to a subject that is derived from received signals. Image data may be output to one or more output devices 26 coupled to processor 48, such as a storage device, communication link, such as a network hub, another computer or server, a printer, or directly to a display device, such as a video monitor. Processor 48 may also be coupled to an input device 52 such as a keyboard, cursor controller, touch-screen display, another processor, a network, or other device, communication link, such as a source of information for operating the system or supplemental information relating to a given subject. As discussed further below, input device 52 of imaging system 20 may include an external sensor, such as a scale for use in determining the body mass or weight of a subject, such as a scale built into a platform on which a person stands during scanning. An external sensor, such as an optical, infrared or ultrasonic camera or other device, may be used to determine the height or thickness (width and depth) of a subject.

In some embodiments, processor 48 may be coupled to memory 50 for storing data, such as one or more data sets generated by processor 48, or operating instructions, such as instructions for processing data. Memory 50 may be a single device or a combination of devices, and may be local to the processor or remote from it and accessible on a communication link or network. Operating instructions or code 54 may be stored in memory 50, and may be embodied as hardware, firmware, or software.

Data generated by the processor may thus be sent to and retrieved from memory 50 for storage. In some examples, data generated from scanning a given subject may be retrieved for further processing, such as identifying information corresponding to a feature of the subject, for modifying image data, or for generating an image of a subject or portion of a subject derived from received signals. In such examples, the processor may be configured to identify or compare information corresponding to the features, such as identification of body portions, body orientation, or body features. In some examples, one or more data sets generated from scanning a given subject at a given time may be stored in memory 48, and then may be compared with one or more data sets generated from scanning the subject at a later time, such as sequential scans when a person's body is in different orientations. In some examples, the processor may be configured to identify information in multiple data sets, each generated at a different time, but corresponding to the same given feature of the subject, to compare the information corresponding to the feature at different times, and to compare the information for different portions of the person's body.

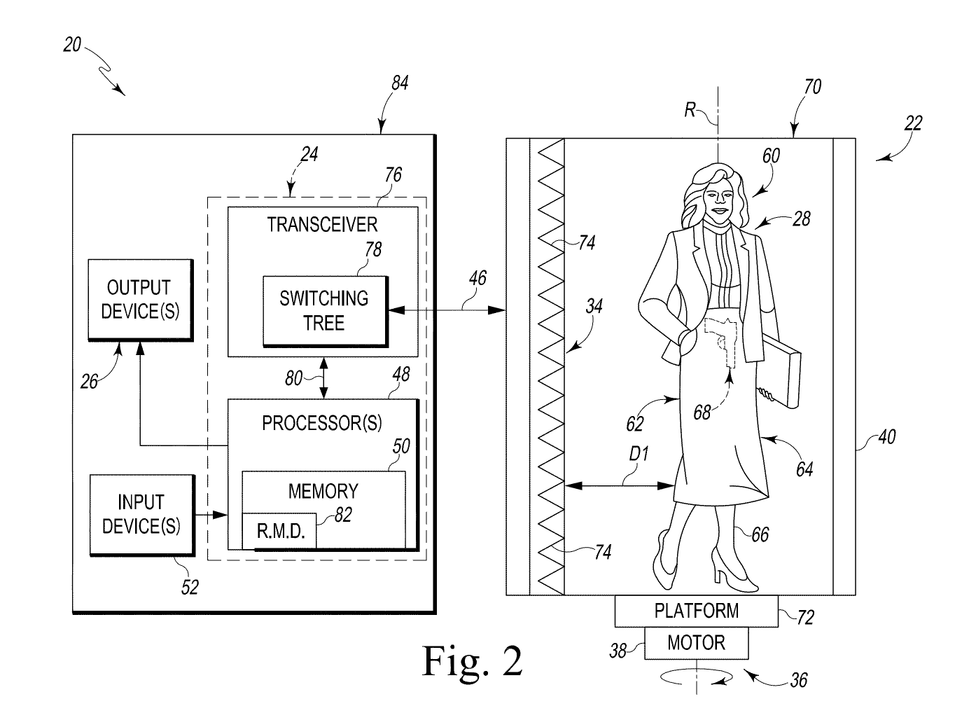

An imaging system, such as that illustrated in FIG. 1, may be used for scanning in a variety of applications in which the controller may be configured to identify information in one or more data sets corresponding to one or more features of a subject. A second example of an imaging system 20 is illustrated in FIG. 2. In imaging system 20, a subject 28 may include a person 62 presented for scanning by system 20. System 20 may have a target position 60 where the subject is directed to stand during scanning. Person 62 is shown wearing clothing 64 over her or his body 66, which clothing conceals an object 68, shown in the form of a weapon. Subject 28 may be positioned in an interrogation station or portal 70 of system 20 extending partially around the target position. Portal 70 may be configured in various ways for placement at a security checkpoint where it is desired to detect objects, such as weapons or contraband, on the person. Portal 70 may include, for example, a platform 72 connected to motion mechanism 36 in the form of motor 38. Platform 72 may be arranged to support subject 28. Motor 38 may be arranged to selectively rotate the platform about rotational axis R located in the center of the target position while subject 28 is positioned thereon. For the configuration shown, axis R may be vertical, and subject 28 may be in a generally central target position 60 relative to axis R and platform 72.

Scanner 22 may include an antenna apparatus 74 including a primary multiple-element sensing array 34. The scanner 22 may include a frame 40 on which array 34 is supported. Array 34 may extend the full height of frame 40. Motor 38 may cause platform 72, and subject 28 to rotate about axis R. As a result, array 34 circumscribes a generally circular pathway about axis R. The antenna array may be about 0.5 to about 2 meters from radius R.

Antenna array 34 may include a number of linearly arranged elements 74 of which only a few are schematically illustrated. Each element 74 may be dedicated to transmission or reception of radiation or both, and the elements may be arranged in two generally vertical columns, with one column dedicated to transmission, and the other to reception. The number and spacing of the elements corresponds to the wavelengths used and the resolution desired. A range of 200 to about 600 elements can span a vertical length of about two or two and one-half meters.

Various other configurations for portal 70 and scanner 22 may be used. For example, a two-dimensional transmit and receive array may be used, as well as an array that moves around a fixed subject platform, or an array that moves vertically and extends horizontally. Further, many variations of an antenna apparatus are possible. The antenna apparatus may include one or more antenna units, and each antenna unit may include one or more transmitting antennae and one or more receiving antennae. An antenna unit may include a plurality of antennae that may receive radiation in response to transmission by a single antenna. The antennae may be any appropriate type configured to transmit or receive electromagnetic radiation, such as a slot line, patch, endfire, waveguide, dipole, semiconductor, or laser. Antennae may both transmit and receive. The antenna units may have one or more individual antennae that transmit or receive like polarization or unlike polarized waveforms such as plane, elliptical, or circular polarization, and may have narrow or broad angular radiation beam patterns, depending on the application. Beam width may be relatively broad, i.e. 30 to 120 degrees for imaging applications that use holographic techniques, while narrow beam widths in the range of 0 to 30 degrees may be used for applications having a narrow field of view requirement.

Further, a single antenna may scan a subject by mechanically moving about the subject in a one- or two-dimensional path. A one- or two-dimensional array of antenna units may electronically and mechanically scan a subject. An imaging system may include one or a plurality of antenna apparatus. The antennae apparatus may be protected from the environment by suitable radome material, which may be part of the apparatus, or separate, depending on the mechanical motion that is required of the antennae apparatus or array. Examples of other array configurations are illustrated in copending patent application Ser. No. 10/728,456.

A controller 24 may control operation of scanner 22. Controller 24 may include a transceiver 76 including a switching tree 78 configured to irradiate subject 28 with only one transmitting element 74 at a time, and simultaneously receive with one or more elements 74. Transceiver 76 may include logic to direct successive activation of each combination of transmit and receive antenna elements to provide a scan of a portion of a subject 28 along a vertical direction as platform 72 and the subject rotate.

An image signal 46 received from array 34 may be downshifted in frequency and converted into an appropriate format for processing. In one form, transceiver 76 may be of a bi-static heterodyne Frequency Modulated Continuous Wave (FM/CW) type like that described in U.S. Pat. No. 5,859,609. Other examples are described in U.S. Pat. Nos. 5,557,283 and 5,455,590. In other embodiments, a mixture of different transceiver and sensing element configurations with overlapping or non-overlapping frequency ranges may be utilized, and may include one or more of the impulse type, monostable homodyne type, bi-static heterodyne type, and/or other appropriate type.

Transceiver 76 may provide image data 80 corresponding to the image signals to one or more processors 48. Processor 48 may include any suitable component for processing the image data, as appropriate. Processor 48 may be coupled to a memory 50 of an appropriate type and number. Memory 50 may include a removable memory device (R.M.D.) 82, such as a tape cartridge, floppy disk, CD-ROM, or the like, as well as other types of memory devices.

Controller 24 may be coupled to motor 38 or other drive element used to selectively control the rotation of platform 72. Controller 24 may be housed in a monitor and control station 84 that may also include one or more input devices 52, such as operator or network input devices, and one or more displays or other output devices 26.

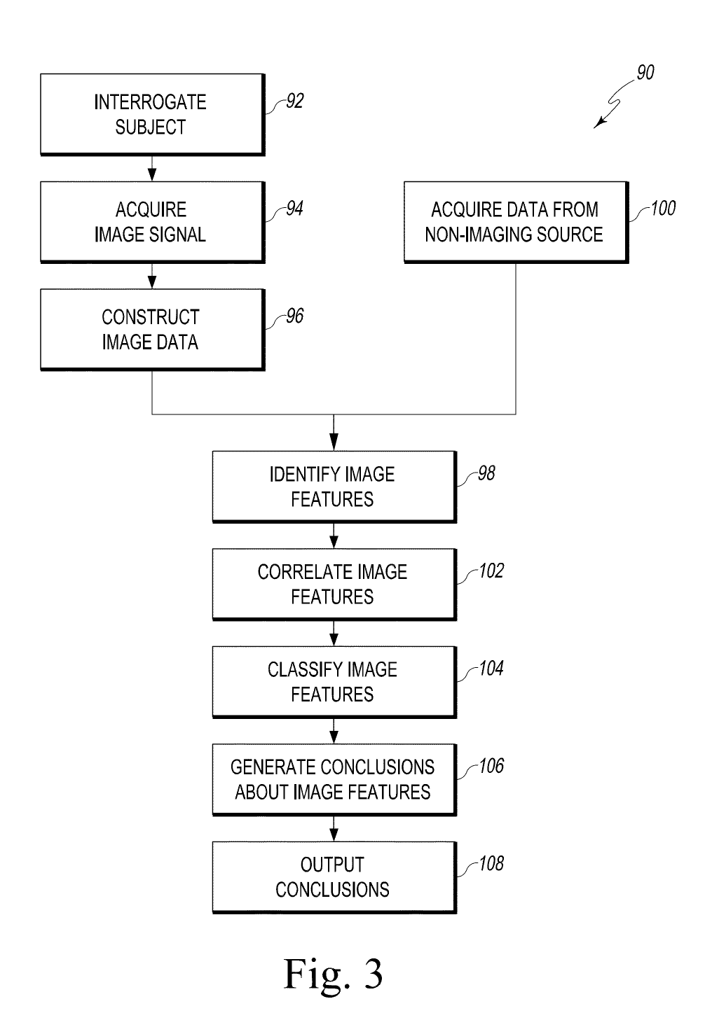

A general flow chart 90, illustrating exemplary operation of surveillance system 20, is shown in FIG. 3. Two data acquisition phases are illustrated. Scanner 22 scans a subject 28 at 92. Image information is detected during the scanning and an image signal is generated. Processor 48 acquires the image signal at 94. The acquired image signal is then processed at 96 to construct image data. Image data is analyzed to identify image features at 98. As is explained further below, image features or characteristics derived from image data may be any identifiable aspect of the image data or associated image, such as the shape, configuration, arrangement, texture, location of one or more objects 68 relative to a person's body 66, or features of the person's body, such as orientation, position, texture, specific body parts, size, shape, configuration, symmetry, or other appropriate aspect.

One or more input devices 52 may be a source of image data, such as subject information, and may be separate from a scanner, such as a data base with information on a particular person. The data from a supplemental source may be acquired at 100. A supplemental source also may be a sensor that detects general features of the subject 28, such as the general detection of a substance, a feature identifying or measuring the person 62, or context data stored in a memory relating to the subject. Such supplemental image features may also be identified at 98. The existence of a substance, an identification of the person or a characteristic, class or categorization of the person, and other appropriate indicators or information may be features of the subject, in addition to features identified from the image data. Examples of features of the image data may include the location of features of the image that may correspond to an object or a specific part of the body, such as the head, legs, torso or the like, the characteristics of the body in a particular area, or the other appropriate features.

The various identified image features may then be correlated with each other at 102. For example, the identification of an object on the side of a person from an imaging apparatus may be correlated with the detection of metal in the middle zone of the person, a badge identifying the person, and context data previously stored in memory indicating that the person is a security guard and has high security clearance.

The identified or correlated features may then be classified at 104. The classification of features is a logical process for determining the likelihood that detected features correspond to a suspect object or a false alarm. For example, the detection of various characteristics or certain combinations of characteristics in the same zone of an image may indicate that the image portion is an object. Further, given that the person is identified as a security guard, it is highly likely that the object is a gun. Also, the person may be authorized to carry a gun in this position as part of her duties. The object would thus be given a high weight of being a suspect object, but given a low weight as a security risk, due to the status of the person as a security guard.

Any set of corresponding features can be assigned a corresponding relative indicator, such as weight, value or attribute. An area of a subject may thus be assigned a high value even though no image object is detected. For example, a sheet of plastic explosive taped to a person's body may appear smoother than the rest of the person's body. The structure of an object also may be the basis of assigning a value, such as dimensions, shape and edge characteristics.

Once the image features are classified, then conclusions are generated at 106 about the combinations of image features. The conclusions may then be output at 108, as appropriate, such as via a display, report or alarm condition.

The remaining figures illustrate various exemplary procedures for identifying features of a subject from image data received by a processor, such as processor 48 receiving data from a scanner 22. Generally, these images represent data. The steps described may be performed without actually producing a displayed image, or without producing data that provides visual characteristics suitable for display. Accordingly, many of the images presented are presented in visual form to facilitate an understanding of the associated processes, but formation or display of the associated data may be optional.

Generally, a method of surveilling may include scanning a subject, including one or more persons and detectable objects, with electromagnetic radiation in a frequency range of about 100 MHz to about 2 THz, and generating from the scanning image data representative of at least an image of at least a portion of the person's body. The image may be formed by a matrix of picture elements, also referred to as pixels, or simply pels. As has been mentioned, these various images represent data. The steps described may be performed without actually producing a displayed image, or without producing data that provides visual characteristics suitable for display. The images in the figures are intended to facilitate an understanding of the processes described, and are not necessarily a part of the associated process. An imaging system 20 adapted to identify objects on a person's body may display the subject or identified objects on a monitor or other display device for observation by a system operator or other user. An image of a subject 28 may distinguish between portions of the image that relate to the subject and portions of the image that relate to the background, including structure other than the subject. This distinction may be provided in an image by variation in a value of a feature, such as intensity, color and/or a topographical data, such as depth or distance from a reference.

Due to the nature of the scanner 22, there may be inconsistencies or anomalies in portions of the image where the background has intensity levels similar to those of the subject, and the subject has intensity levels similar to the background. This image, representing the associated image data, may be analyzed to determine the location of the body or a body part, such as the top of the head. This analysis may include or be based in whole or in part on an analysis of any appropriate feature or features of the data, such as the intensity levels of the pixels. Determination of a selected aspect of the image may include one or more features.

Data represented by image data may be used to determine a feature of the body, such as the location of a body part or region or a dimension. However, improved reliability of the results may be provided by additional processing. As an example, an image may be morphed (transformed) by modifying the image based on features of the image. Morphing image data may be considered modifying or altering the image data by applying one or more morphological operators, such as operators described in U.S. Pat. No. 7,386,150 and referred to as dilation, erosion, closing and opening.

Specific examples may include applying a specific transform kernel to the image pixels, or by processing pixels in an appropriate way, such as by modifying values based on pixel values in a window associated with a pixel. For example, a pixel value may be replaced by the lowest, highest, average or other value determined from pixels in an m x n window, such as a 7-pixel wide by 3-pixel high window, with the affected pixel located in the center of the window. Many variations of such a process are possible for producing morphed images with various corresponding characteristics. Further, a combination of such techniques may be used on the same image or image portion or on different portions of an image region.

For different scans, a person may be positioned in different orientations. The orientation of the person or other subject may be useful in determining features of the image, such as determining where on an image of the person's body objects carried by the person may likely be positioned, or a measurement of the thickness of the person at different selected vertical positions.

The above techniques describe exemplary ways for locating a part of the subject's body, such as the top of the head, and also determining the orientation of the subject relative to the scanner. Such techniques may be useful for further image processing, such as determining a characteristic of the image as represented by image data, or for altering an image.

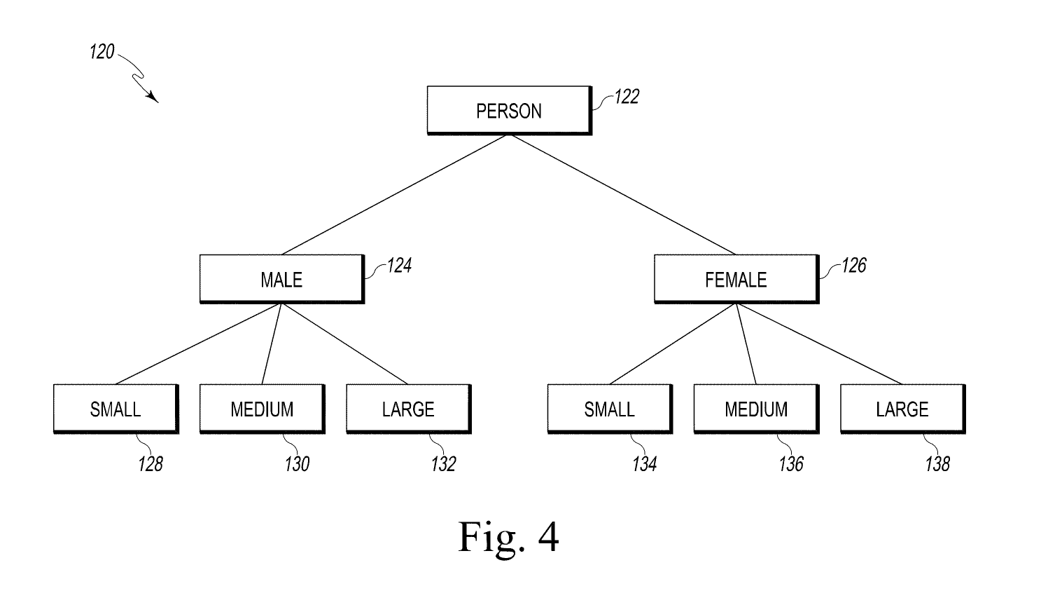

FIGS. 4-6 illustrate techniques that may be used in automatic threat detection (ATD) of objects on human bodies using a detected or observed build or shape of the body. The detection method may use body shapes such as, for example, male vs. female and skinny vs. heavy body types to better discriminate objects from the body background. Detecting the presence of objects on human bodies is commonly obscured by the normal variation in body shape across a large population, causing variable positive detection performance across large populations.

Initially, a classifier may be created to analyze scan images of a person to identify anomalies or objects of interest on the person. By automating this in a dependable process, scanning of persons can be accomplished rapidly with a higher level of confidence in the results. As shown in the previous figures, images that result from millimeter-wave imaging include significant amounts of what may be referred to as noise or artifacts that are not directly related to the person. A classifier may be created for categories of bodies having certain features in common. For example, categories may be established based on gender, height, weight, body shape (height relative to weight), skeletal structure, genetic characteristics, or other observed characteristics that are suitable for distinguishing one category of people from another.

During the analysis of a scanned image of a person, the category of the person's body is determined. A method of detection of anomalies of a person then uses reference information, such as one or more reference images or parameters of the selected body category. The performance of the detection method may therefore be enhanced by using reference information belonging to the same body category as the person being scanned. In the following discussion, reference is made to the use of body shape for classifying a scanned image, it being understood that other categories may be used in addition to or instead of body shape.

The body shape can be determined both manually and automatically. A manual determination may be performed by a human operator observing the subject and entering the appropriate data into a console. For example, the male or female body shape could be determined by an operator pressing a button designated for males or another one for females. Other characteristics may also be observed, such as whether the person is tall or short, whether the person is relatively heavy or lean, or a blend of such characteristics. As shown in FIG. 4, there may be a further definition of each person in addition to gender, such as small, medium, or large as determined by a formula combining weight and height. There may be several levels of observed categories of a person, then, including, gender, height, weight, and skeletal structure.

The imaging system may make an automatic determination without input by an operator or in addition to input by an operator, based on an analysis of the scan data and other acquired data as appropriate. Scan data may include both depth images and intensity images. A comparison of depth images for the front of a person and the back of a person may provide a front-to-back measurement of the body thickness at one or more points on the body such as chest and abdomen. Body width could also be detected by comparing depth images for both sides of a person. As described previously, intensity images may be analyzed to provide measurements of the body height from head to feet and body width from side-to-side. These measurements can be combined to give an indicator of body shape. For example, a ratio R=depth/height may be determined that quantifies the body shape with a number. Higher values of R indicate heavier or fatter people while smaller R's indicate lighter or slimmer people.

Body mass or weight may be measured using an external scale, such as a scale built into a platform on which a person stands during scanning. This may be used to determine a body mass index. Height can be determined for use in the calculation by using an external sensor, such as optical, infrared or ultrasonic devices, in addition to or instead of the scan data itself. A trained boosted classifier may also be used for head detection.

Measurements may be made at selected locations on a person in order to standardize and normalize the measurements. For example, the depth or thickness of a person's body may be measured from the front and back depth images at a position, P, near the navel on the abdomen. The vertical height of P may be determined using other known dimensions of the person, and may be estimated to be a fixed portion, such as two-thirds, of the height to the top of the head. In a front view, the horizontal position of P may be set equal to the horizontal position of the head. The resulting depth distance between the front and back sides may then be normalized by the height to yield the ratio R=depth/height ratio. Using the value of R, then, a body type may be assigned according to values of R previously computed for known body types.

FIG. 4 illustrates an example of a three-tier classification scheme shown generally at 120. A classification scheme may provide various levels of classification depending on the level of detection performance desired or available in a particular application. At a first tier, only a single class of subjects may be identified. In this example, the subject is classified as a person at 122. To provide a further tier or level of detection performance, people may be distinguished according to physical body characteristics, such as gender, height, weight, thickness, or skeletal structure. In the example, one of the classes is based on gender and include male at 124 and female at 126. Given the classification of a test subject as either male or female, the test-subject image data may be compared to reference-subject image data corresponding to representative images of people that are either male or female as appropriate. If a different physical characteristic could better distinguish a particular population that is being scanned, that characteristic may be used instead.

For each member of the first class, a third tier may be used to distinguish among members of the population that belong to the second tier classification. In this example, each test subject may be further classified according to a different physical characteristic. In this example, the body type may be further classified by the general body shape. Body shape may be determined by a measurement of body thickness, by a measured weight, or by determining a body/mass index based on weight and height or thickness and height. A number of subclasses may be established to further improve the detection of anomalous areas from test-image data. In this example, the third-tier subclasses are small, medium, and large body types. The male test subject will thus be classified as one of a small body type at 128, a medium body type at 130, or a large body type at 132.

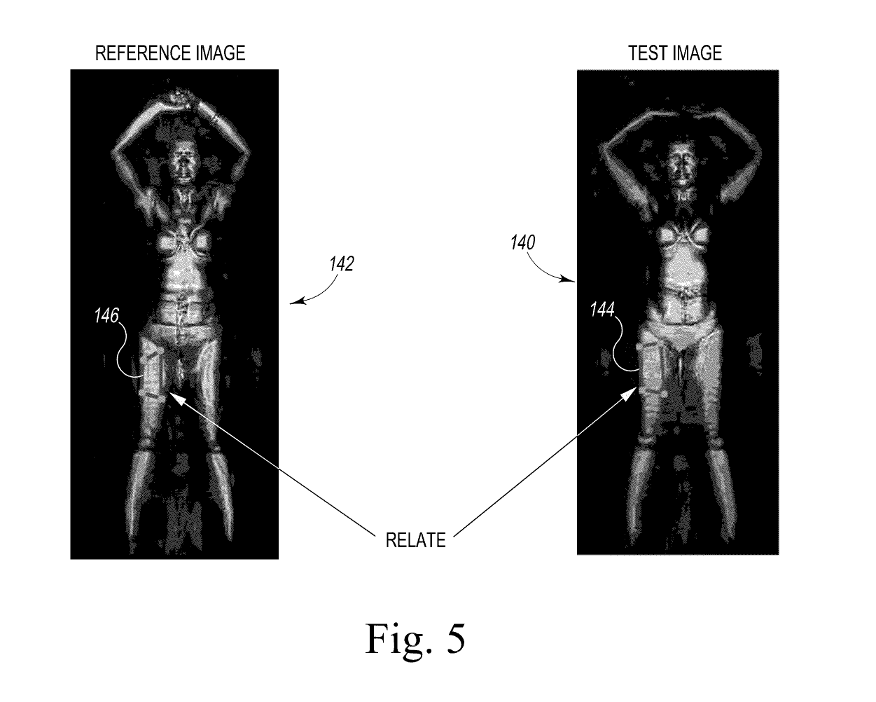

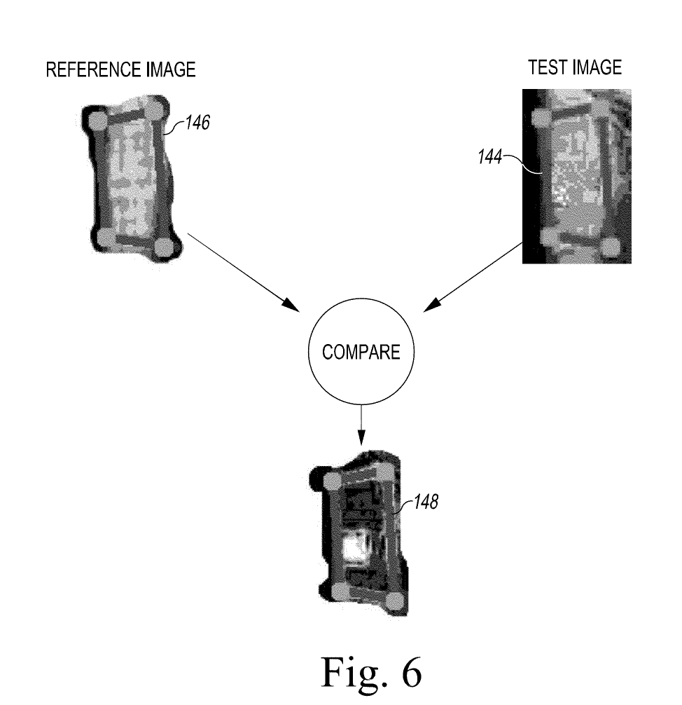

FIGS. 5 and 6 illustrate the use of reference data in detecting a possible object by comparing a test image to reference data representative of a class or subclass. The output of the compare operation has been visualized as an image to help explain the method but creating such an image is not necessary in the actual use of the methods and systems described herein.

Specifically, FIG. 5 illustrates a subject test image 140 of a subject 28 made from an imaging system 20, with a person facing an observer or reference position. Test image 140 may represent for each pixel or (x,y) coordinate, the highest response from a series of depth or distance measurements from the antenna array 34 to the subject 28. The depth measurements indicate the location of the surface of the subject in the z-direction, which is the direction normal to the plane of image 140. The intensities are retrieved at the depth of the subject's surface and placed into a separate image that results in the images shown in FIG. 5.

Detection of an anomaly may use the determined body shape. For example, a completely different classifier may be established for each body shape. That is, known body shapes of a given body type may be used to select reference images to compare to a scan image. As is illustrated in FIG. 5 as a first tier of classification, the test subject in this example is a person having classification 122 in FIG. 4. Additionally, at a second tier, the test subject is a female having a classification 126. As a further example, this person may be assigned to the subclass 136 for medium-sized females.

Reference data may be stored in memory for each class or subclass of body type. The reference data may be collected from many reference subjects. This reference data may then be referenced in a simple way as a reference image, or it may involve more complex analysis and be analyzed in terms of features. For subclass 136, as a simple example, a reference image such as reference image 142 may be used. In analyzing test image 140 for anomalies, regions that have been predefined or regions that have been identified as special by their features such as region 144 in test image 140 may be related or compared to reference data for a corresponding region 146 in reference image 142 of a similar person known to not have an object, or it may be compared to reference data of a similar person known to have a particular type of object. For example, a person that is heavier may have image features or characteristics due to constraints put on certain parts of the body by clothing typically worn by such a person.

In other examples, different parameter values within a single classifier may be tuned for different body shapes and then used to establish appropriate thresholds for object detection. In yet other examples, a training library may be established for each body shape using known features derived from images of persons with the associated body shape. As the body shape indicator can take on a value that varies continuously in a range of values, a range of body shape indicators may be encompassed within a particular body type. A particular body shape classification in practice may thus include a set or range of body shape indicators spanning a specified range of body shapes. The number and widths of these sets of body shapes are additional parameters that may be adjusted in defining the classifications.

Body shape information may thus be used to create classifiers that are optimized for different body shapes. In one example, the range of body shapes may be partitioned into three groups: thin, medium, and thick, and these groups may be partitioned by gender. Image data for these body types may exhibit different features that are characteristic of each group. For instance a thin person may have a bony clavicle that is distinct in the image data, whereas a thick person may have shirt sleeve reflections, skin folds, or an extended belly. Undergarments may also show more clearly for large or thick persons. Females may have bra lines that do not exist for males.

In this example, two classifiers are trained: Classifier A is trained with scans from all three groups while Classifier B is trained with scans from just the medium group. Similarly, Classifier A is optimized with scans from all three groups while Classifier B is optimized with scans from just the medium group. Finally, Classifier A is applied when the test subject is thin or thick and Classifier B is applied when the test subject is medium. Using these techniques, automatic target recognition (ATR) analysis may thereby exhibit higher positive detections and lower false alarms, and thereby better performance.

A classifier may be created for each class or subclass of interest, such as a classifier for thin, another classifier for medium, and yet another classifier for thick. In practice, however, finding people with a medium body type may be relatively easy while finding thin and thick people may be more difficult. If not enough reference information is available, separate robust classifiers for thin and thick people, for example, may not be possible. In this case a classifier may be generated from all groups for classifying thin and thick people, whereas a classifier generated from just medium people may be used to classify medium people, thereby achieving better classification results for at least the medium people as discussed above.

Many techniques may be used to compare or relate the two images to accentuate or identify differences between the two images, or more generally, to compare test data with reference data. As used, the test data may be represented by features computed from the test images, and data for both intensity and depth images may be used. For example, computed features may include textures instead of or in addition to intensity alone. The reference data may be represented by features computed from many reference images. This reference data may then be analyzed in terms of features and reduced into a suitable form for use in a classifier.

A comparison operation computes a figure-of-merit (FOM) for each pixel from the test and reference feature data. The FOM may be a scalar quantity so it could be visualized for illustration purposes as an FOM image, similar to the bottom image shown in FIG. 6. A FOM includes the idea of “difference” between test and reference data, as described below with reference to FIG. 6, as a special case. The FOM may then be compared against a threshold to determine the presence or absence of an object.

As an example and referring to FIG. 6, the characteristics of test-image features of test data corresponding to image portion 144 from test image 140 may be compared to characteristics of reference-image features of reference data corresponding to image portion 146 of reference image 142. In a simple example, the comparison may involve a pixel-by-pixel comparison. For example, the pixel intensities in the reference image may be subtracted from the pixel intensities in the test image, leaving a difference image, such as difference image 148. In this simple example of comparing two intensity images, it is seen that an area of interest that shows up as a bright area in the test image is given a higher level of contrast to the surrounding body areas, indicating that there is an anomaly in this area. The difference image or more generally the FOM can then be compared to the known statistics or images for objects, or pixels patterns and features characteristic of known objects or otherwise analyzed to determine the presence or absence of an object, and if present the likely type of object that it is. Additionally or alternatively, the suspect area may be identified in a display to an operator to alert her or him to examine the test subject to determine what the object is. From the foregoing, it will be appreciated that an example of a method of scanning a test subject with an imaging apparatus is provided, where the test subject includes a person and any discernible objects with the person. The method may include, prior to scanning the test subject, storing in the memory of the imaging apparatus reference-image data for at least one reference subject produced from an earlier image signal received during the scanning of at least one reference subject with electromagnetic radiation in a range of about 100 MHz to about 2 THz; transmitting by the imaging apparatus toward a target position in which the test subject is positioned, electromagnetic radiation in a frequency range of about 100 MHz to about 2 THz, from positions spaced from the target position; receiving from the test subject electromagnetic radiation emitted from the test subject in response to the transmitted electromagnetic radiation; producing an image signal representative of the received radiation; producing from the image signal test-image data corresponding to a test-subject image of at least a portion of the test subject; and comparing at least a portion of the test-image data with a corresponding at least a portion of the reference-image data for at least one reference subject.

The method may further include determining whether the test image data includes characteristics corresponding to an object on the person based at least in part by the comparison of at least a portion of the test-image data with at least a portion of the reference-image data for at least one reference subject. Determining whether the test image data includes characteristics corresponding to an object includes comparing the test-subject image data with corresponding reference-image data.

In some examples, the method may include assigning the test-subject to an assigned group selected from at least two groups determined according to a physical characteristic discernible in the reference-image data and the test-image data. Storing reference-image data for at least one reference subject may include storing reference-image data for many reference subjects divided into at least two groups. Further, comparing the test-image data with the reference-image data may include comparing the at least a portion of test-image data with at least a portion of the reference-image data for the assigned group.

The method may further include determining by the surveillance apparatus the first physical characteristic of the test subject from the test-image data. The physical characteristic may be based on gender, height, weight, thickness, and/or skeletal structure.

In some examples, the method may further include assigning the test-subject to a subgroup selected from at least two subgroups determined according to a second physical characteristic discernible in the reference-image data and the test-image data. The second physical characteristic may be different than the first physical characteristic. Storing reference-image data may include storing reference-image data for many reference subjects divided into at least two.

In some examples, an imaging apparatus may include a scanning or interrogating apparatus and a controller. The scanning or interrogating apparatus may be configured to transmit toward and receive from a test subject, including a person and any discernible objects with the person, in a target position, electromagnetic radiation in a frequency range of about 100 MHz to about 2 THz, from positions spaced from the target position. The scanning apparatus may produce an image signal representative of the received radiation. The controller may include a processor and a memory. The memory may store reference-image data for at least one reference subject produced from an earlier image signal received during the scan of the at least one reference subject with electromagnetic radiation in a range of about 100 MHz to about 2 THz. The controller may be configured to compare the image signal test-image data with the reference-image data for at least one reference subject. Such an imaging apparatus and controller may be configured to perform the foregoing method steps.

In some examples, one or more non-transitory storage media may have embodied therein a program of commands configured to be executed by a computer processor of an imaging apparatus to store by the imaging apparatus reference-image data for at least one reference subject produced from an earlier image signal received during the scan of at least one reference subject with electromagnetic radiation in a range of about 100 MHz to about 2 THz; transmit by the imaging apparatus toward a target position in which a test subject is positioned, electromagnetic radiation in a frequency range of about 100 MHz to about 2 THz, from positions spaced from the target position; receive from the test subject electromagnetic radiation emitted from the test subject in response to the transmitted electromagnetic radiation; generate an image signal in response to the received electromagnetic radiation; produce an image signal representative of the received radiation; produce from the image signal test-image data corresponding to a test-subject image of at least a portion of the test subject; and compare at least a portion of the test-image data corresponding to the test-subject image with a corresponding at least a portion of the reference-image data for at least one reference subject. Such storage media may have the program embodied thereon instructions configured to be executed to perform the foregoing method steps.

While embodiments of imaging systems and methods for imaging, and storage media have been particularly shown and described, many variations may be made therein. This disclosure describes and illustrates one or more independent or interdependent inventions directed to various combinations of features, functions, elements and/or properties, one or more of which may be defined in the following claims. Other combinations and sub-combinations of features, functions, elements and/or properties may be claimed later in this or a related application. Such variations, whether they are directed to different combinations or directed to the same combinations, whether different, broader, narrower or equal in scope, are also regarded as included within the subject matter of the present disclosure. An appreciation of the availability or significance of claims not presently claimed may not be presently realized. Accordingly, the foregoing embodiments are illustrative, and no single feature or element, or combination thereof, is essential to all possible combinations that may be claimed in this or later applications. The claims, accordingly, define inventions disclosed in the foregoing disclosure, but any one claim does not necessarily encompass all features or combinations that may be claimed. Where the claims recite “a”, “a first”, or “at least one” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

### INDUSTRIAL APPLICABILITY

The methods and apparatus described in the present disclosure are applicable to security, monitoring and other industries in which surveillance or imaging systems are utilized.

What is claimed is:

1. A method of interrogating a test subject with an imaging apparatus, the test subject including a person and any discernible objects with the person, the method comprising:
prior to interrogating the test subject, storing in a memory of the imaging apparatus reference-image data for at least one reference subject produced from an earlier image signal received during interrogation of the at least one reference subject with electromagnetic radiation in a range of about 100 MHz to about 2 THz;
transmitting by the imaging apparatus toward a target position in which the test subject is positioned, electromagnetic radiation in a frequency range of about 100 MHz to about 2 THz, from positions spaced from the target position;
receiving from the test subject electromagnetic radiation emitted from the test subject in response to the transmitted electromagnetic radiation;
producing an image signal representative of the received radiation;
producing from the image signal test-image data corresponding to a test-subject image of at least a portion of the test subject; and
comparing at least a portion of the test-image data with a corresponding at least a portion of the reference-image data for the at least one reference subject.

2. The method of claim 1, further comprising determining whether the test image data corresponding to the test-subject image includes characteristics corresponding to an object on the person based at least in part by the comparison of at least a portion of the test-image data corresponding to the test-subject image with a corresponding at least a portion of the reference-image data for the at least one reference subject.

3. The method of claim 2, wherein determining whether the test image data corresponding to the test-subject image includes characteristics corresponding to an object includes determining whether the test-image data corresponding to the test-subject image includes characteristics corresponding to an object on the person, and comparing the test-subject image data having characteristics corresponding to an object with corresponding reference-image data.

4. The method of claim 1, further comprising assigning the test-subject to an assigned group selected from at least two groups determined according to a first physical characteristic discernible in the reference-image data and the test-image data; and wherein storing reference-image data for at least one reference subject includes storing reference-image data for a plurality of reference subjects divided into the at least two groups; and comparing at least a portion of the test-image data with a corresponding at least a portion of the reference-image data includes comparing the at least a portion of the test-image data with a corresponding at least a portion of the reference-image data for the assigned group.

5. The method of claim 4, further comprising determining by the surveillance apparatus the first physical characteristic of the test subject from the test-image data.

6. The method of claim 4, wherein the first physical characteristic is based on at least one of gender, height, weight, thickness, and skeletal structure.

7. The method of claim 4, further comprising assigning the test-subject to an assigned subgroup selected from at least first and second subgroups for each of the at least two groups determined according to a second physical characteristic discernible in the reference-image data and the test-image data and different than the first physical characteristic; and wherein storing reference-image data for a plurality of reference subjects divided into the at least two groups includes storing reference-image data for a plurality of reference subjects divided into the at least first and second subgroups for each of the at least two groups; and comparing the at least a portion of the test-image data with a corresponding at least a portion of the reference-image data for the assigned group includes comparing the at least a portion of the test-image data with a corresponding at least a portion of the reference-image data for the assigned subgroup.

8. The method of claim 7, wherein the second physical characteristic is based on at least one of gender, height, weight, thickness, and skeletal structure.

9. An imaging apparatus comprising:
an interrogating apparatus configured to transmit toward and receive from a test subject, including a person and any discernible objects with the person, in a target position, electromagnetic radiation in a frequency range of about 100 MHz to about 2 THz, from positions spaced from the target position, the interrogating apparatus producing an image signal representative of the received radiation; and
a controller including a processor and a memory, the memory storing reference-image data for at least one reference subject produced from an earlier image signal received during interrogation of the at least one reference subject with electromagnetic radiation in a range of about 100 MHz to about 2 THz, the controller configured to produce from the image signal test-image data corresponding to a test-subject image of at least a portion of the test subject, and compare at least a portion of the test-image data corresponding to the test-subject image with a corresponding at least a portion of the reference-image data for the at least one reference subject.

10. The imaging apparatus of claim 9, in which the controller is further configured determine whether the test image data corresponding to the test-subject image includes characteristics corresponding to an object on the person based at least in part on the comparison of at least a portion of the test-image data corresponding to the test-subject image with a corresponding at least a portion of the reference-image data for the at least one reference subject.

11. The imaging apparatus of claim 10, in which the controller is further configured to determine whether the test-image data includes characteristics corresponding to an object on the person, and comparing the test-subject image data with corresponding reference-image data.

12. The imaging apparatus of claim 9, in which the controller is further configured to assign the test-subject to an assigned group selected from at least two groups determined according to a first physical characteristic discernible in the reference-image data and the test-image data; and store reference-image data for a plurality of reference subjects divided into the at least two groups; and compare the test-image data with the reference-image data for the assigned group.

13. The imaging apparatus of claim 12, in which the controller is further configured to determine the first physical characteristic of the test subject from the test-image data.

14. The imaging apparatus of claim 12, wherein the first physical characteristic is based on at least one of gender, height, weight, thickness, and skeletal structure.

15. The imaging apparatus of claim 12, in which the controller is further configured to assign the test-subject to an assigned subgroup selected from at least first and second subgroups for each of the at least two groups determined according to a second physical characteristic discernible in the reference-image data and the test-image data and different than the first physical characteristic; and store reference-image data for a plurality of reference subjects divided into the at least first and second subgroups for each of the at least two groups; and compare the at least a portion of the test-image data with a corresponding at least a portion of the reference-image data for the assigned subgroup.

16. The imaging apparatus of claim 15, wherein the second physical characteristic is based on at least one of gender, height, weight, thickness, and skeletal structure.

17. One or more non-transitory storage media having embodied therein a program of commands adapted to be executed by a computer processor of an imaging apparatus to:
store by the imaging apparatus reference-image data for at least one reference subject produced from an earlier image signal received during interrogation of the at least one reference subject with electromagnetic radiation in a range of about 100 MHz to about 2 THz;
transmit by the imaging apparatus toward a target position in which a test subject is positioned, electromagnetic radiation in a frequency range of about 100 MHz to about 2 THz, from positions spaced from the target position;
receiving from the test subject electromagnetic radiation emitted from the test subject in response to the transmitted electromagnetic radiation;
generate an image signal in response to the received electromagnetic radiation;
produce an image signal representative of the received radiation;
produce from the image signal test-image data corresponding to a test-subject image of at least a portion of the test subject; and
compare at least a portion of the test-image data with a corresponding at least a portion of the reference-image data for the at least one reference subject.

18. The storage media of claim 17, in which the program embodied therein is further configured to be executed by the computer processor to determine whether the test image data corresponding to the test-subject image includes characteristics corresponding to an object on the person based at least in part by the comparison of at least a portion of the test-image data corresponding to the test-subject image with a corresponding at least a portion of the reference-image data for the at least one reference subject.

19. The storage media of claim 18, in which the program embodied therein is further configured to be executed by the computer processor to determine whether the test-image data corresponding to the test-subject image includes characteristics corresponding to an object on the person, and compare the test-subject image data having characteristics corresponding to an object with corresponding reference-image data.

20. The storage media of claim 17, in which the program embodied therein is further configured to be executed by the computer processor to assign the test-subject to an assigned group selected from at least two groups determined according to a first physical characteristic discernible in the reference-image data and the test-image data, and store reference-image data for a plurality of reference subjects divided into the at least two groups, and compare at least a portion of the test-image data with a corresponding at least a portion of the reference-image data includes comparing the at least a portion of the test-image data with a corresponding at least a portion of the reference-image data for the assigned group.

21. The storage media of claim 20, in which the program embodied therein is further configured to be executed by the computer processor to determine the first physical characteristic of the test subject from the test-image data.

22. The storage media of claim 20, wherein the first physical characteristic is based on at least one of gender, height, weight, thickness, and skeletal structure.

23. The storage media of claim 20, in which the program embodied therein is further configured to be executed by the computer processor to assign the test-subject to an assigned subgroup selected from at least first and second subgroups for each of the at least two groups determined according to a second physical characteristic discernible in the reference-image data and the test-image data and different than the first physical characteristic; store reference-image data for a plurality of reference subjects divided into the at least first and second subgroups for each of the at least two groups; and compare the at least a portion of the test-image data with a corresponding at least a portion of the reference-image data for the assigned subgroup.

24. The storage media of claim 23, wherein the second physical characteristic is based on at least one of gender, height, weight, thickness, and skeletal structure.
